(19) United States
(12) Patent Application Publication
(10) Pub. No.: US 2020/0253360 A1
(43) Pub. Date: Aug. 13, 2020

(54) POWER TOOL HAVING A BACKPACK-HOUSED POWER SUPPLY

(71) Applicant: BRIGGS & STRATTON CORPORATION, Wauwatosa, WI (US)

(72) Inventors: Ryan HAHN, Wauwatosa, WI (US); Warren CORRADO, Wauwatosa, WI (US); Kyle HARVEY, Wauwatosa, WI (US); Matthew ZURAWSKI, Wauwatosa, WI (US); Jacob SCHMALZ, Wauwatosa, WI (US); Joseph GIACALONE, Wauwatosa, WI (US)

(73) Assignee: BRIGGS & STRATTON CORPORATION, Wauwatosa, WI (US)

(21) Appl. No.: 16/755,075

(22) PCT Filed: Oct. 12, 2018
(86) PCT No.: PCT/US2018/055593

§ 371 Date: Apr. 9, 2020

Related U.S. Application Data
(60) Provisional application No. 62/572,008, filed on Oct. 13, 2017.
(60) Provisional application No. 62/639,219, filed on Mar. 6, 2018.

(51) Int. Cl. A45F 3/14; A01D 34/90; H01M 2/10

(52) U.S. Cl. CPC A45F 3/14; A01D 34/902; A45F 2003/146; H01M 2220/30; H01M 2/1066

(57) ABSTRACT

A backpack system for use with a power tool, the system including a harness system configured to extend at least over a user's shoulders, and a carrier portion configured to be coupled to the harness system. At least one battery pack is housed within the carrier portion, and at least one electrical connector is coupled to the at least one battery pack, with the at least one battery pack being configured to provide power to the power tool. The carrier portion may further include at least one opening formed therein to allow the passage of air at least partially through the carrier portion. The power tool may be a string trimmer or a blower. Additionally, one or more carrier portions may be recharged in a recharging station which is configured to allow for hands-free connection of a carrier portion to a user's harness system.

### CROSS-REFERENCE TO RELATED APPLICATIONS

The present application claims priority to both U.S. Provisional Patent Application No. 62/572,008, filed Oct. 13, 2017, and U.S. Provisional Patent Application No. 62/639,219, filed Mar. 6, 2018, the disclosures of which are each incorporated by reference herein in their entirety.

### BACKGROUND

The present disclosure relates generally to power tools, particularly those for use in lawn and garden applications such as, e.g., hand-held string trimmers and other hand-held power tools. More particularly, the disclosure relates to power tools having at least one power source (e.g., at least one battery pack) housed in an operator-worn backpack.

Hand-held lawn and garden power tools such as, e.g., blowers, string trimmers, hedge trimmers, etc. are commonly used by both residential and commercial operators. Generally, these hand-held tools have been powered by small, two-stroke internal combustion engines or by corded electric motors. While the two-stroke internal combustion engines allow the power tools to be used remotely and for relatively extended periods of time, the presence of the engine may generate undesirable noise, exhaust, and vibration, and also increases the weight of the tool, making it uncomfortable to use for extended periods of time. Conversely, power tools using corded electric motors, while often lighter in weight and quieter, have limited range due to the need for the tool to remain in proximity to an electrical power outlet.

More recently, hand-held lawn and garden power tools have been developed using an on-board, rechargeable battery pack to power at least one electric motor in the tool. The battery pack may contain any number of battery cells having any appropriate chemistry, such as lead acid, Ni-Cad, lithium ion, etc. Furthermore, the battery pack may be removed and replaced on the tool when depleted. However, this feature requires the user to carry (and/or recharge) multiple battery packs in order to extend run time of the power tool, making conventional battery-powered lawn and garden power tools less desirable to commercial users, as their use of the tools throughout the work day may necessitate numerous battery pack changes. Additionally, the on-board battery pack adds weight to the power tools, potentially making prolonged use of the tools uncomfortable. Also, due to form-factor restrictions for the on-board battery packs, the amount of power provided by these rechargeable battery packs is generally limited.

### SUMMARY

In accordance with an aspect of the disclosure, a backpack system for use with a power tool is disclosed. The backpack system includes a harness system, wherein the harness system is configured to extend at least over a user's shoulders. The backpack system may also include a carrier portion, wherein the carrier portion is configured to be coupled to the harness system. The backpack may also include at least one battery pack housed within the carrier portion. Additionally, at least one electrical connector coupled to the at least one battery pack and configured to provide power to the power tool may be provided. The carrier portion may further include at least one opening formed therein to allow the passage of air at least partially through the carrier portion.

According to another aspect of the disclosure, a backpack system for use with a power tool is disclosed. The backpack system may include a harness system, wherein the harness system is configured to extend at least over a user's shoulders. The backpack system may also include a carrier portion, wherein the carrier portion is configured to be coupled to the harness system. Furthermore, the backpack system may include at least one battery pack housed within the carrier portion. At least one electrical connector coupled to the at least one battery pack and configured to provide power to the power tool may also be provided. Additionally, the carrier portion may be removably couplable to the harness system.

According to another aspect of the disclosure, a recharging station for battery packs is disclosed. The recharging station may include at least one receptacle configured to receive a first side of a carrier portion of a backpack, wherein the carrier portion is configured to house at least one battery pack therein. The carrier portion may include a connection interface on a second side of the carrier portion, the connection interface configured to couple the carrier portion to a user-worn harness system. The recharging station may also include at least one power source configured to provide electrical energy to the at least one receptacle so as to charge the at least one battery pack within the carrier portion.

In accordance with another aspect of the disclosure, an electric motor-driven handheld power tool is disclosed. The electric motor-driven handheld power tool may include an electric motor and a grip portion. The power tool may also include a first shaft portion extending between the electric motor and the grip portion. Additionally, the power tool may include a second shaft portion extending between the grip portion and a distal implement, wherein the second shaft portion and the first shaft portion are offset from one another to form an S-bend shape. The power tool may further include a flexible drive shaft extending through the first shaft portion, the grip portion, and the second shaft portion to couple the electric motor to the distal implement.

According to another aspect of the disclosure, an electric motor-driven string trimmer is disclosed. The string trimmer may include an electric motor, a rotary cutting head, and a grip portion. The string trimmer may also include at least one shaft portion extending between the grip portion and the rotary cutting head. The rotary cutting head may be configured to be angularly adjustable relative to the at least one shaft portion. Additionally, the angular position of the rotary cutting head may be controlled by a user via one or more of an actuator, a pivotable handle portion, and a rotatable handle portion.

### BRIEF DESCRIPTION OF THE DRAWINGS

FIG. 1A is a rear perspective view of a backpack housing at least one battery pack for use with a power tool in accordance with an aspect of the disclosure;

FIG. 1B is a side view of the backpack shown in FIG. 1A;

FIG. 2 is a perspective view of a battery storage and charging system for use with a backpack battery system in accordance with another aspect of the disclosure;

FIG. 3A is a perspective view of a carrier portion of the backpack battery system of FIG. 2;

FIG. 3B is a rear perspective view of a user vest and carrier portion coupling interface of the backpack battery system of FIG. 2;

FIG. 3C is a perspective view of the connectors for coupling the carrier portion with the user vest of the backpack battery system of FIG. 2;

FIG. 4A is a perspective view of a backpack battery system in a coupled position on a storage and charging base in accordance with another aspect of the disclosure;

FIG. 4B is a perspective view of the backpack battery system of FIG. 4A in a decoupled position on the storage and charging base;

FIG. 5A is a perspective view of a backpack battery system and a hand-held string trimmer in a first orientation in accordance with another aspect of the disclosure;

FIG. 5B is another perspective view of the backpack battery system and hand-held string trimmer of FIG. 5A in a second orientation;

FIG. 6A is a side view of a hand-held string trimmer in accordance with another aspect of the disclosure;

FIG. 6B is another side view of the hand-held string trimmer of FIG. 6A;

FIG. 7A is a side view of a hand-held string trimmer in a first configuration in accordance with another aspect of the disclosure;

FIG. 7B is a side view of the hand-held string trimmer of FIG. 7A in a second configuration;

FIG. 8A is a rear perspective view of a backpack battery system and hand-held string trimmer in a first configuration in accordance with another aspect of the disclosure;

FIG. 8B is a rear perspective view of the backpack battery system and hand-held string trimmer of FIG. 8A in a second configuration;

FIG. 9A is a rear perspective view of a backpack battery system and hand-held string trimmer in accordance with another aspect of the disclosure;

FIG. 9B is a partial rear perspective view of the hand-held string trimmer of FIG. 9A;

FIG. 9C is a perspective view of a gimbal mechanism of the hand-held string trimmer of FIG. 9A;

FIG. 10 is a side view of an articulating handle for a hand-held string trimmer in accordance with another aspect of the disclosure;

FIG. 11A is a partial perspective view of a hand-held power tool handle and display in accordance with another aspect of the disclosure; and

FIG. 11B is another view of the display of FIG. 11A.

### DETAILED DESCRIPTION

The following description is made for the purpose of illustrating the general principles of the present system and method and is not meant to limit the inventive concepts claimed in this document. Further, particular features described in this document can be used in combination with other described features in each of the various possible combinations and permutations.

Unless otherwise specifically defined in this document, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. Unless defined otherwise, all technical and scientific terms used herein have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used herein, the term “comprising” means “including, but not limited to”. Additionally, use the term “couple”, “coupled”, or “coupled to” may imply that two or more elements may be directly connected or may be indirectly coupled through one or more intervening elements.

In this document, position-identifying terms such as “distal”, “proximal”, “vertical”, “horizontal”, “front”, “rear”, “top”, and “bottom” are not intended to limit the invention to a particular direction or orientation, but instead are only intended to denote relative positions, or positions corresponding to directions shown when a backpack battery system and/or hand-held power tool is oriented as shown in the Figures.

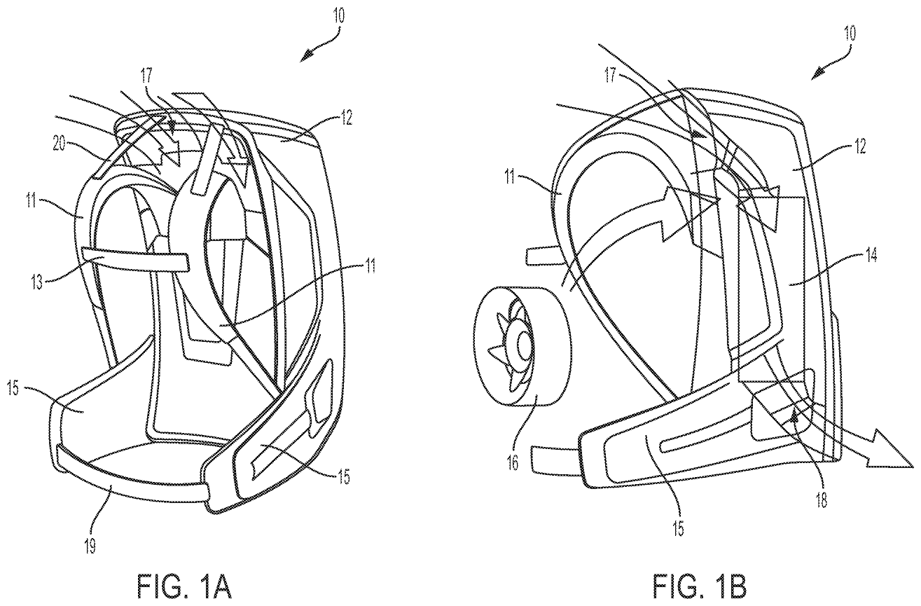

Referring to FIGS. 1A-1B, a backpack system 10 in accordance with an aspect of the disclosure is shown. Backpack system 10 may be configured to hold at least one battery pack 14 for use with at least one power tool (not shown). Backpack system 10 is configured to be worn over the shoulders of a user via a harness system, which, in FIGS. 1A-1B, is configured as a pair of shoulder straps 11 coupled to a carrier portion 12. A hip belt 15 may also be utilized to distribute at least some of the weight of carrier portion 12 to the user's hips. Both should straps 11 and hip belt 15 may be padded to increase user comfort. Additionally, an adjustable hip strap 19 and adjustable chest strap 13 may be present to allow the user to customize the fit of the backpack system 10, and a pair of top straps 20 may be configured to be coupled between the respective shoulder straps 11 and a top portion of carrier portion 12 in order to better stabilize and distribute the weight of carrier portion 12.

As shown in FIG. 1B, at least one battery pack 14 is retained within carrier portion 12. Carrier portion 12 may be formed of any appropriate material or combination of materials, such as, e.g., plastic, metal, composites, fabric, etc. The at least one battery pack 14 may be any appropriate battery pack of any appropriate size and chemistry capable of powering a hand-held power tool for extended periods of time, such as, e.g., one or more lithium ion battery packs, one or more Ni-Cad battery packs, one or more lead acid battery packs, etc. The at least one battery pack 14 may be removable from the carrier portion 12 to allow for remote recharge and/or replacement. Conversely, the at least one battery pack 14 and carrier portion 12 may include a connector (not shown) allowing for direct recharge of the at least one battery pack 14 without its removal from carrier portion 12.

The user may wear the backpack system 10 for extended periods of time when operating the attached power tool(s), particularly if user is a commercial user. With such extended use, heat build-up at the user-facing side of carrier portion 12 may occur due to both the user's own body heat and any heat dissipated by the at least one battery pack 14. Accordingly, backpack system 10 may include an active cooling system utilizing, e.g., one or more fans 16 housed on or within carrier portion 12 to draw cooling air through an upper portion of the carrier portion 12. The one or more fans 16 may be powered by the at least one battery pack 14 or, alternatively, may be powered by a dedicated power source. Carrier portion 12 may have a vent or opening 17 formed in an upper portion thereof, with the one or more fans 16 configured to draw air through the vent or opening 17. Consequently, the air passes by the user's head and neck, providing cooling air to the user during use of the backpack system 10. The cooling air may then be drawn through carrier portion 12 such that it passes substantially over the at least one battery pack 14, thereby also providing cooling to the at least one battery pack 14. An additional vent or opening 18 may be formed in a lower region of the carrier portion 12 and be configured to direct air away from the user, thereby allowing the cooling air that passed over at least one battery pack 14 to exit the carrier portion 12.

In addition to the cooling air drawn over the user's head and neck by the one or more fans 16, backpack system 10 may also include one or more sprayers (not shown) on a top region of carrier portion 12, which may be configured to provide a constant or intermittent cooling mist on the head and/or neck of the user. Alternatively, backpack system 10 may incorporate a passive cooling system, which may include an elongated channel (not shown) running through the user-facing side of carrier portion 12 from a lower opening to an upper opening. Due to convection, air may naturally rise through channel, thereby providing cooling air to both the user's back and the at least one battery pack 14. Additionally, the upper opening on carrier portion 12 may include one or more vents (not shown), with the one or more vents being configured to direct air drawn through the elongated channel in the direction of the user's head and/or neck, providing the user with even more cooling.

While FIGS. 1A-1B illustrate a backpack system 10 utilizing one or more fans to provide active cooling, it is to be understood that the system may also utilize one or more additional and/or alternative means for active cooling. For example, backpack system 10 may incorporate cooling water running through tubes adjacent to the user's back, a cooling mist emitted from one or more sprayers on the backpack system 10, one or more pouches configured to hold removable ice packs, etc. In this way, backpack system 10 is not limited to only the active cooling means shown and described with respect to FIGS. 1A-1B and/or the passive cooling means described above.

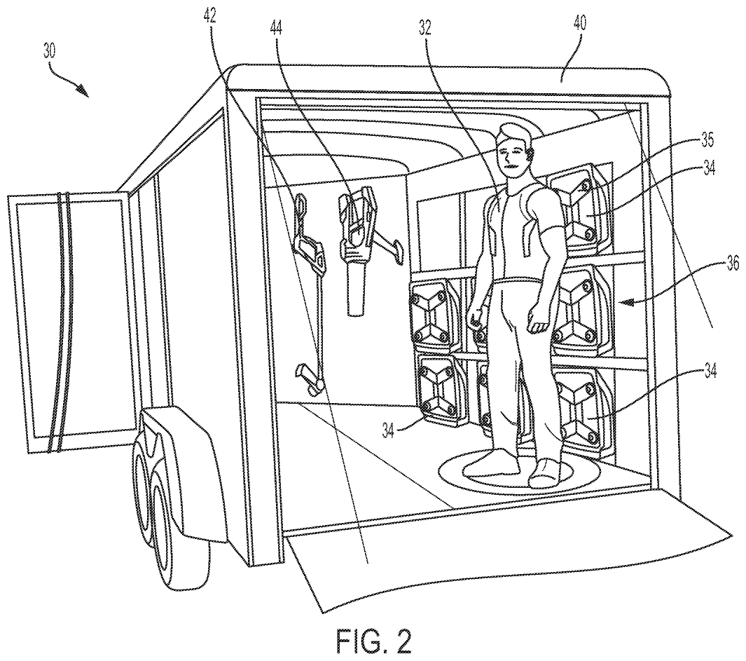

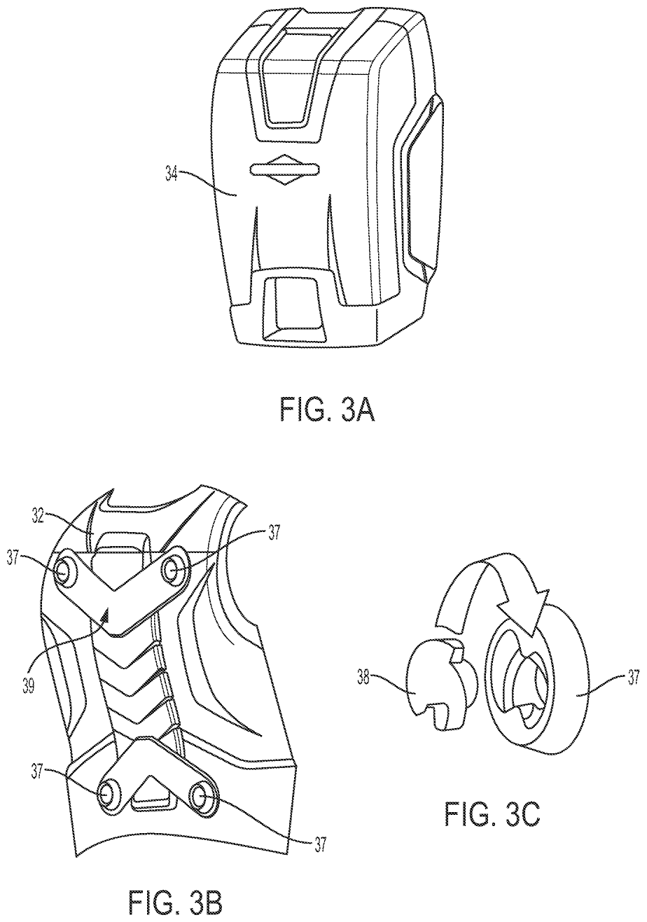

Referring to FIG. 2, a backpack charging system 30 in accordance with another aspect of the disclosure is shown. Specifically, FIG. 2 illustrates a backpack charging system 30 for use in conjunction with a power tool such as, e.g., a string trimmer, a blower, etc. Backpack charging system 30 includes a vest 32 and a carrier portion 34, shown in more detail with respect to FIGS. 3A-3C, wherein carrier portion 34 is removably attachable to a rear side of vest 32, as opposed to backpack-style straps described above with respect to backpack system 10 shown in FIGS. 1A-1B. Similar to the carrier portions described above, carrier portion 34 is configured to hold at least one battery pack therein, wherein the at least one battery pack is utilized to power an electric power tool. Vest 32 may be constructed of any appropriate material, such as, e.g., cotton, polyester, elastic materials, mesh materials, and/or any combination thereof. Vest 32 may be sized and configured to be worn in a form-fitting manner on the user's torso, thereby enabling vest 32 to evenly distribute the weight of an attached carrier portion 34 and substantially prevent shifting of carrier portion 34 when in use. Additionally and/or alternatively, vest 32 may include one or more adjustable straps and/or elastic bands to enable the user to further customize the fit of vest 32, and vest 32 may be include high-visibility coloring and/or reflectors.

As shown in FIGS. 3A-3C, vest 32 is configured to enable simplified attachment and removal of carrier portion 34. Specifically, FIG. 3B shows a rear portion of vest 32, which includes a connection interface 35. Connection interface 35 may, in some embodiments, be formed of a more rigid material than other materials used to construct vest 32, such as, e.g., plastic, metal, composites, etc. In this way, connection interface 35 provides a platform upon which carrier portion 34 may be securely attached. Connection interface 35 may include one or more couplers 37, wherein couplers 37 are configured to allow for removable attachment of carrier portion 34 to vest 32. As shown in FIG. 3C, each coupler 37 may be configured as a quarter-turn fastener capable of mating with a complimentary coupler 38 located on a rear, user-facing surface of carrier portion 34. In this way, carrier portion 34 may be attached and/or removed from vest 32 by way of a simple, quarter-turn movement of one of the carrier portion 34 or the vest 32. Additionally and/or alternatively, couplers 37, 38 may be magnetic to provide for secure attachment of carrier portion 34 to vest 32. While FIG. 3C illustrates a quarter-turn fastener, it is be understood that couplers 37, 38 are not limited to such an arrangement, and may be configured as any appropriate fastener capable of allowing selective attachment and detachment of carrier portion 34 to vest 32. Additionally, while FIG. 3B illustrates the use of four couplers 37 on vest 32, it is to be understood that more or fewer couplers 37 may be utilized, with more or fewer complimentary couplers 38 also being used on the carrier portion 34.

Referring to FIG. 2, a storage and/or charging rack system 36 for use in conjunction with vest 32 and carrier portions(s) 34 of backpack charging system 30 is shown. Storage and/or charging rack system 36 is shown as being housed in an equipment trailer 40, which may be transportable by vehicle to and from various remote worksites, and which may further be configured to hold various forms of outdoor power equipment, including hand-held blowers 44 and string trimmers 42. Storage and/or charging rack system 36 may be configured to hold a plurality of carrier portions 34 in rows and/or columns, with a connection interface 39 of each carrier portion 34 facing towards the inside of the equipment trailer 40. Accordingly, the user may easily access a given carrier portion 34 prior to or during their workday for attachment to a worn vest 32. In some embodiments, storage and/or charging rack system 36 may be configured to enable the user to attach and/or detach carrier portion(s) 34 to their vest 32 without removal of vest 32 from the user's body. That is, while wearing vest 32, the user may simply move backwards in the direction of storage and/or charging rack system 36 until the respective couplers 37, 38 (described above with respect to FIGS. 3A-3C) mate within one another so as to connect carrier portion 34 to vest 32. This operation may be reversed when the user wishes to remove a carrier portion 34 from vest 32 for recharge and/or replacement. Alternatively and/or additionally, the user may manually remove a carrier portion 34 from storage and/or charging rack system 36, and the user (or another) may manually connect the selected carrier portion 34 to the vest 32.

In some aspects, storage and/or charging rack system 36 may provide electrical energy to each carrier portion 34 stored thereon, thereby allowing for the carrier portions 34 to be recharged when not in use. The electrical energy may be provided to carrier portion 34 through any appropriate means, such as, e.g., a utility grid connection, a bank of batteries, a bank of solar panels, etc. Additionally and/or alternatively, while illustrated in FIG. 2 as being housed within an equipment trailer 40, it is to be understood that storage and/or charging rack system 36 may be housed in another location, such as, e.g., a garage, office, or other building.

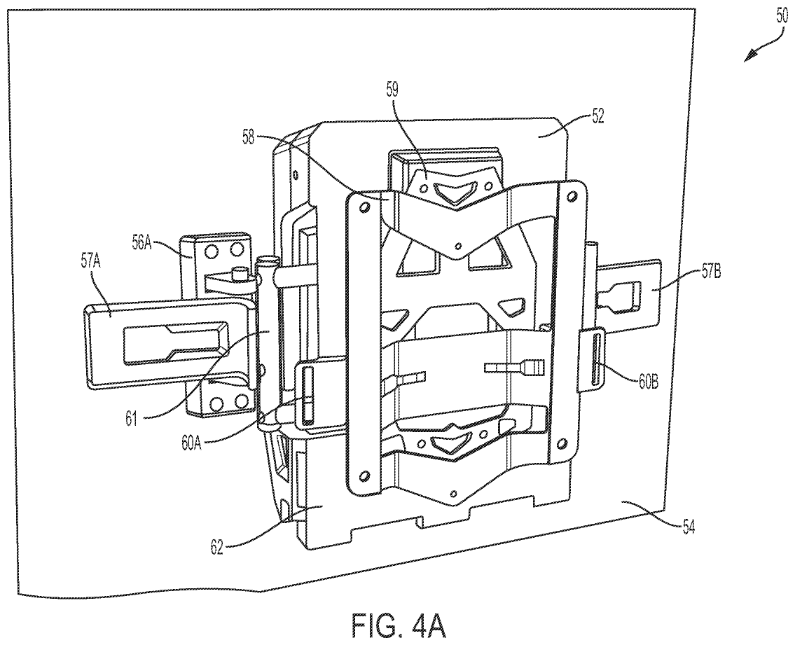

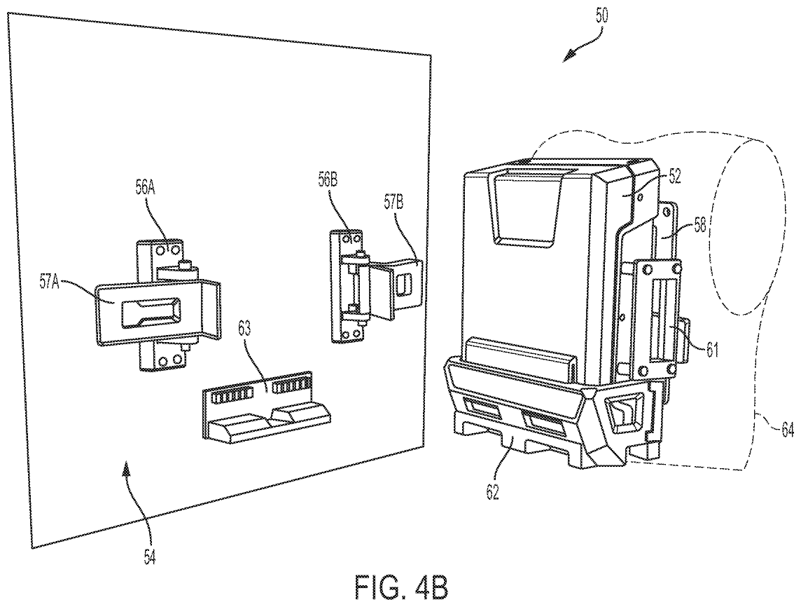

Next, referring to FIGS. 4A-4B, battery storage and/or charging system 50 in accordance with alternative aspect of the disclosure is shown. Similar to the storage and/or charging rack system 36 shown and described with respect to FIG. 2, storage and/or charging system 50 is configured for use in conjunction with a vest, backpack, or other user-worn carrier (e.g., a hip belt). Additionally, storage and/or charging system 50 is shown as being housed on a wall 54, wherein wall 54 may be located in or on a building, in or on an equipment trailer, etc. Furthermore, while only one storage and/or charging system 50 is shown in FIGS. 4A-4B, it is to be understood that more than one storage and/or charging system 50 may be located on wall 54, forming a rack or other configuration similar to that which is shown in FIG. 2.

As shown in FIG. 4A, storage and/or charging system 50 includes a battery housing 52, which is coupled to a battery retainer plate 59. Battery retainer plate 59 includes a pair of latches 60A, 60B, which are configured to pivot toward and away from battery housing 52. The latches 60A, 60B are configured to retain and/or release a carrier portion 58, wherein carrier portion 58 is coupled to, e.g., a user-worn vest 64, as shown in FIG. 4B.

Coupled to wall 54 is a pair of mounting brackets 56A, 56B, wherein each mounting bracket comprises a respective latch 57A, 57B. Similar to latches 60A, 60B, latches 57A, 57B are configured to pivot toward and away from wall 54. Latches 57A, 57B are configured to couple and decouple battery housing 52 from mounting brackets 56A, 56B via a pair of latch interfaces 61 which extend from opposing sides of battery housing 52. When retained on mounting brackets 56A, 56B, a battery pack charging interface 62 on a surface of battery housing 52 is held in electrical contact with a wall charging interface 63, thereby allowing one or more batteries held within the battery housing 52 to be charged and/or monitored. The coupling between battery pack charging interface 62 and wall charging interface 63 may be any appropriate electrical coupling capable of providing charging.

Referring to FIG. 4B, if the user wearing vest 64 wishes to return battery housing 52 for recharging, storage, etc., the user may simply back toward the mounting brackets 56A, 56B and wall charging interface 63 until the pair of latch interfaces 61 are retained by latches 57A, 57B. Each of latches 57A, 57B may be spring (or otherwise) biased such that an audible “click” may be heard by the user when successful alignment and interconnection of the battery housing 52 to the mounting brackets 56A, 56B and wall charging interface 63 is achieved. Then, to release the carrier portion 58 of the user's vest 64 from the battery retainer portion 59 of the battery housing 52, the user may simply pivot latches 60A, 60B so as to cause the release of battery housing 52. This release of latches 60A, 60B may be achieved in any appropriate way, e.g., by manipulation via the user's hands, manipulation by the user's respective elbows, etc. In this way, the user may be released from the battery housing 52, and the battery housing 52 is retained on wall 54 in a storage and/or charging mode, all without the user needing to remove the vest 64 and/or lift battery housing 52.

Conversely, if the user wishes to attach battery housing 52 to the carrier portion 58 of vest 64, the user simply need reverse the steps described above. That is, user may back toward latches 60A, 60B of battery housing 52 until each of latches 60A, 60B properly engage with carrier portion 58. Like latches 57A, 57B, latches 60A, 60B may be spring (or otherwise) biased such that an audible “click” may be heard by the user when successful alignment and engagement with latches 57A, 57B is achieved. Then, to release the latch interfaces 61 from mounting brackets 56A, 56B and the wall charging interface 63, the user may simply pivot latches 57A, 57B so as to cause the release of battery housing 52 from the wall 54. This release of latches 57A, 57B may be achieved in any appropriate way, e.g., by manipulation via the user's hands, manipulation by the user's respective elbows, etc. Once again, this configuration allows the battery housing to be removed from the wall 54 (and its storage/charging position) and attached to the user's vest 64 without the user needing to remove the vest 64 and/or lift battery housing 52.

While not shown in FIGS. 4A-4B, vest 64, carrier portion 58, and/or battery retainer portion 59 may include disconnect pull or strap, which may configured to quickly disconnect battery housing 52 from the user's vest 64 in the event of an emergency or malfunction.

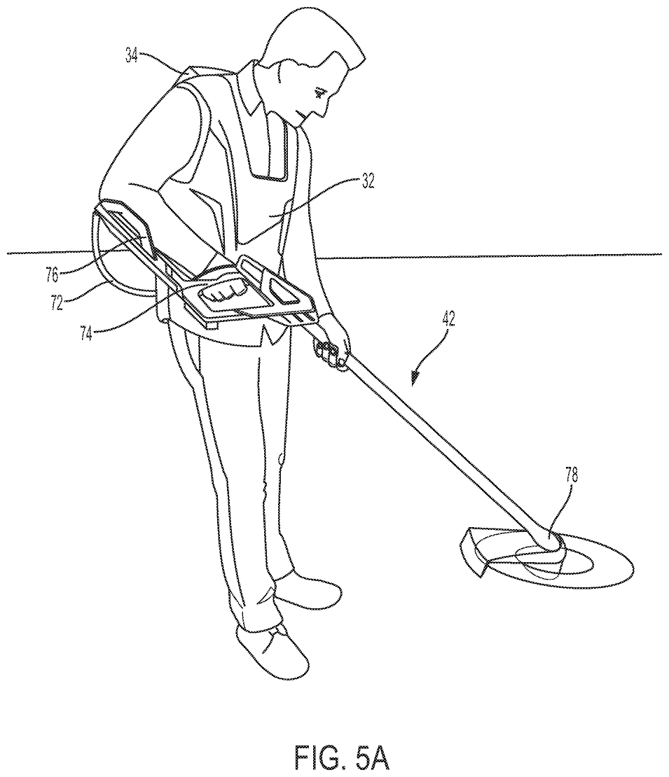

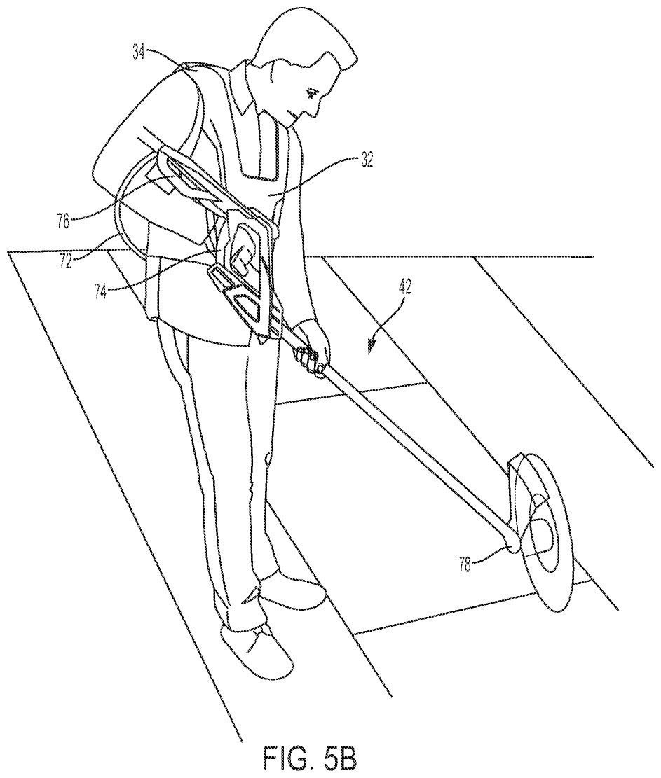

Next, referring to FIGS. 5A-5B, an electric motor-driven handheld power tool in accordance with another aspect of the disclosure is shown. Specifically, a power tool in the form of a string trimmer 42 is disclosed. String trimmer 42 is configured as an electrical, hand-held power tool usable in conjunction with one or more battery packs housed in a carrier portion 34 attachable to a vest 32, similar to the vest 32 and carrier portion 34 described above with respect to FIGS. 2-3C. String trimmer 42 may be electrically connected to the one or more battery packs within carrier portion 34 via an electrical cord 72, with electrical cord 72 being of sufficient length so as to enable the user to easily maneuver string trimmer 42.

String trimmer 42 further includes a handle portion 74, which may be configured as, e.g., a pistol-type grip for user comfort and stability. A distal implement in the form of a rotary head 78 may be located on a distal end of string trimmer 42, with rotary head 78 configured to hold one or more strings to allow for the cutting of weeds or other vegetation when in operation.

Extending from a proximal end of string trimmer 42 and to the rear of handle portion 74 may be a forearm support 76, with handle portion 74 and forearm support 76 forming an approximate S-bend shape. The user-facing side of forearm support 76 may be formed in a substantially cupped shape so as to contact one side of the user's forearm during use, thereby allowing at least some of the weight of string trimmer 42 be distributed to the user's forearm, and further allowing for increased control of string trimmer 42.

As shown in FIG. 5A, string trimmer 42 may be used in a conventional orientation, with rotary head 78 oriented to be substantially parallel to the ground so as to allow the attached string(s) to cut weeds and/or other vegetation. In the orientation shown in FIG. 5A, forearm support 76 is configured to contact a lower portion of the user's forearm and may extend as far as the user's elbow. As noted above, when the user grips handle portion 74 to operate string trimmer 42, forearm support 76 provides for weight distribution and increased control of string trimmer 42.

Turning to FIG. 5B, string trimmer 42 is shown being used in an opposite orientation to the conventional orientation shown and described above with respect to FIG. 5A. In the orientation shown in FIG. 5B, rotary head 78 is orientated substantially parallel to the ground, which causes the attached string(s) to rotate towards the ground, thereby allowing string trimmer 42 to be operated as an edger. With string trimmer 42 in this opposite orientation, forearm support 76 is moved to an upper portion of the user's forearm. However, the user is still able to grip handle portion 74 in a pistol-type grip, and forearm support 76 still may provide for weight distribution and increased control of string trimmer 42, albeit in a reverse orientation to that shown and described above with respect to FIG. 5A.

While FIGS. 5A-5B illustrate a string trimmer 42 utilizing a rotary head 78 as the distal implement, it is to be understood that the S-bend, forearm support, and grip configurations shown and described with respect to FIGS. 5A-5B may be used with other types of power tools using other types of distal implements such as, e.g., hand-held blowers, hand-held hedge trimmers, telescoping branch pruners, edgers, etc.

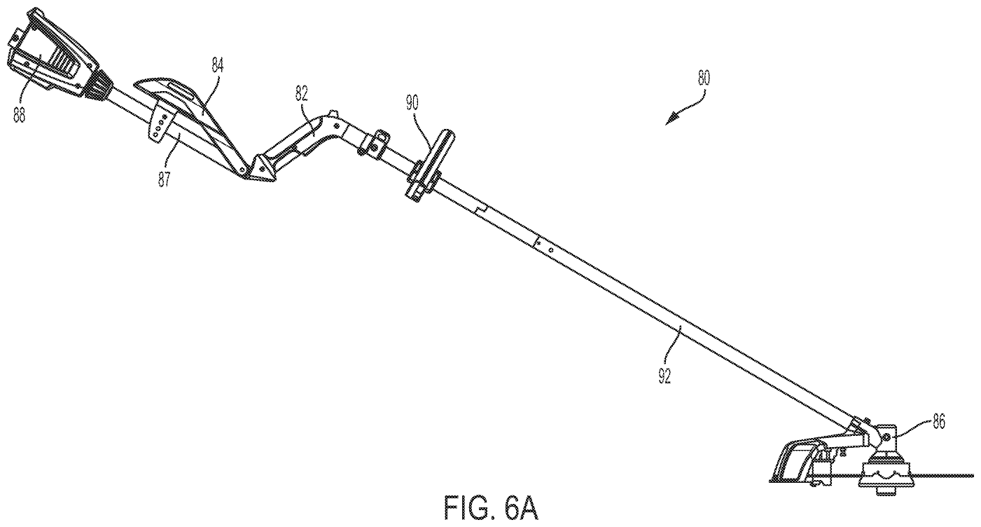

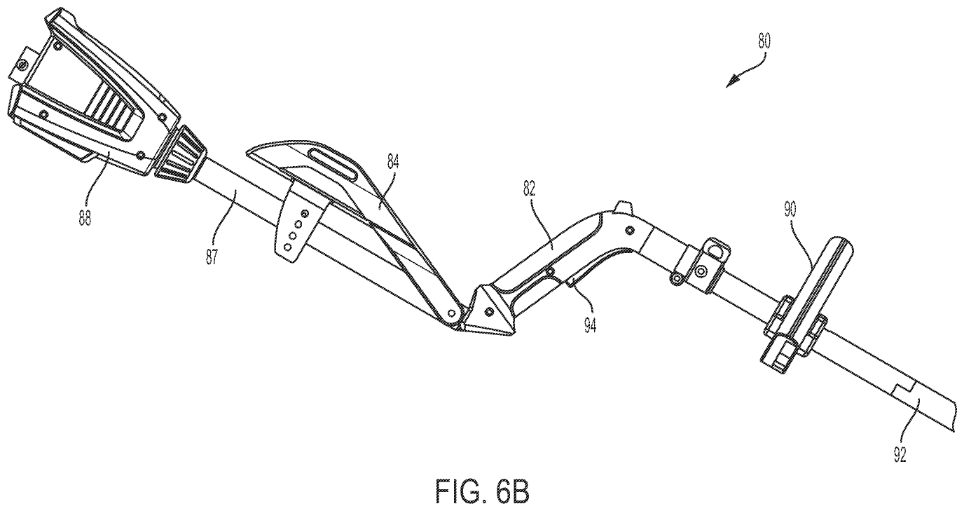

Next, referring to FIGS. 6A-6B, a string trimmer 80 in accordance with another aspect of the disclosure is shown. Similar to string trimmer 42 shown and described with respect to FIGS. 5A-5B, string trimmer 80 is configured as an electrical, hand-held power tool usable in conjunction with one or more battery packs. The one or more battery packs may be external (e.g., held in or on a backpack), or may be mounted on a portion of string trimmer 80.

String trimmer 80 includes a handle portion 82, which may be configured as, e.g., a pistol-type grip for user comfort and stability. The handle portion 82 may include a trigger 94 (or other actuator) to allow the user to control operation of a rotary head 86 of the string trimmer 80. The rotary head 86 may be located on a distal end of a first shaft 92 of string trimmer 80, with rotary head 86 configured to hold one or more strings to allow for the cutting of weeds or other vegetation when in operation.

Opposite the first shaft 92 is a second shaft 87, which is offset from first shaft 92 by the handle portion 82 so as to form an approximate S-bend shape. A forearm support 84 extends along at least a portion of the second shaft 87. The user-facing side of forearm support 84 may be formed in a substantially cupped shape so as to contact one side of the user's forearm during use, thereby allowing some of the weight of string trimmer 80 be distributed to the user's forearm, and further allowing for increased control of string trimmer 80. Additionally, a secondary handle 90 may be provided on or near the first shaft 92, with secondary handle 90 allowing the user to utilize their non-dominant hand (i.e., the hand not gripping handle portion 82) to further support and control string trimmer 80.

Referring still to FIGS. 6A-6B, string trimmer 80 may further include a motor 88 on an end of second shaft 87. While not shown, motor 88 may be electrically coupled to one or more battery packs via, e.g., a flexible power cord extending to a backpack or other battery storage system. Alternatively, motor 88 could be a non-electric motor such as, e.g., a two-stroke or four-stroke internal combustion engine.

Additionally, while not shown in FIGS. 6A-6B, string trimmer 80 may include a flexible drive shaft capable of transferring rotational movement from motor 88 to rotary head 86. In some embodiments, the flexible drive shaft is configured to extend through the second shaft 87, the handle portion 82, and the first shaft 92, thereby allowing the torque imparted by the motor 88 to be transferred to the rotary head 86, even with the S-bend shape of string trimmer 80.

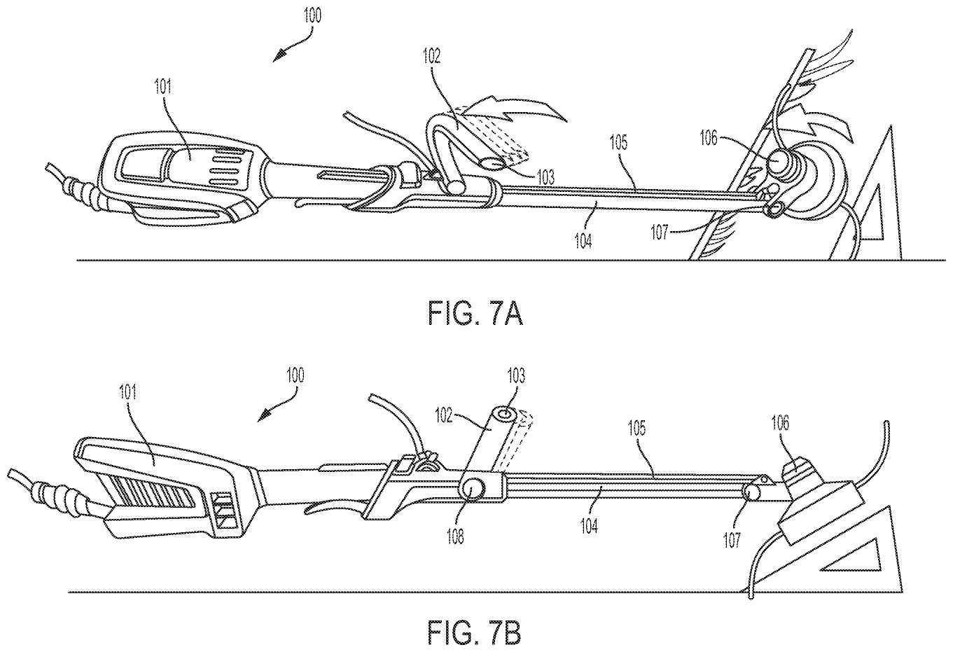

Next, referring to FIGS. 7A-7B, a hand-held string trimmer 100 in accordance with another aspect of the disclosure is shown. String trimmer 100 may include an electric motor 101, a pivotable front grip 102, a shaft 104, and a rotary cutting head 106 disposed on an end of shaft 104. As with the various embodiments described above, string trimmer 100 may be powered by a one or more remotely-stored battery packs. Alternatively, string trimmer 100 may include one or more on-board battery packs.

String trimmer 100 is configurable in both an “edge mode” and a “trim mode”, with the transitions between “edge mode” and “trim mode” being achieved via pivotable front grip 102, which is pivotable about an axis 108 proximate to shaft 104 and coupled to rotary cutting head 106 via a connector 105. As illustrated in FIG. 7A, when a user pulls front grip 102 rearward in a direction of electric motor 101, the connector 105 correspondingly pulls rotary cutting head 106 rearward about an axis 107 such that string trimmer 100 is configured in the “edge mode”, with the rotary cutting head 106 positioned at a relatively steep angle (e.g., 60°) ideal for edging.

Conversely, if the user pushes the pivotable front grip 102 forward, the connector 105 correspondingly pushes rotary cutting head 106 forward about axis 107 such that rotary cutting head 106 is positioned at a lesser angle (e.g., 10°) ideal for vegetation trimming. An actuator 103 may be provided on front grip 102 so as to lock out the rotary cutting head 106 during changes in cutting head angle. In some embodiments, the rotary cutting head 106 may be limited to certain predetermined angular orientations (e.g., the two orientations shown in FIGS. 7A-7B). Alternatively, in other embodiments, rotary cutting head 106 may be adjustable in more than two orientations, and may be infinitely adjustable between two opposite extreme angular settings.

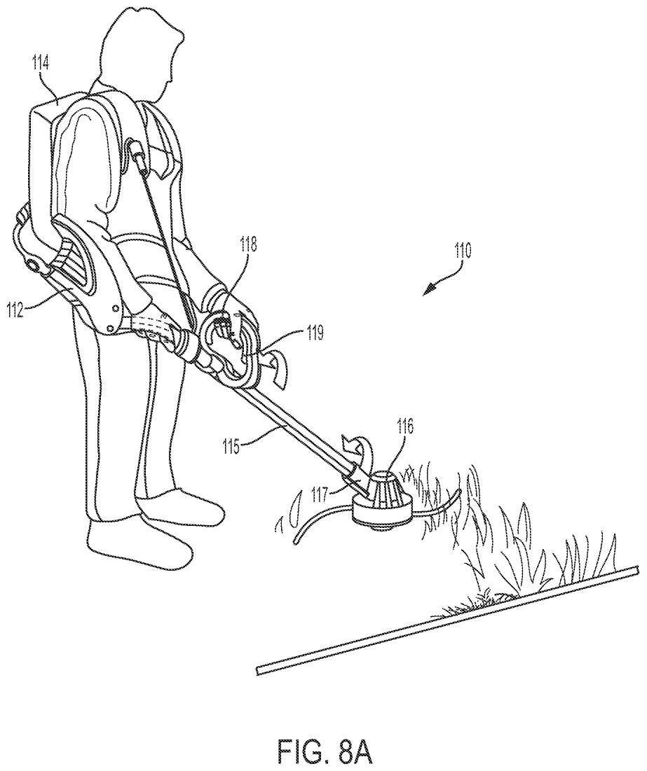

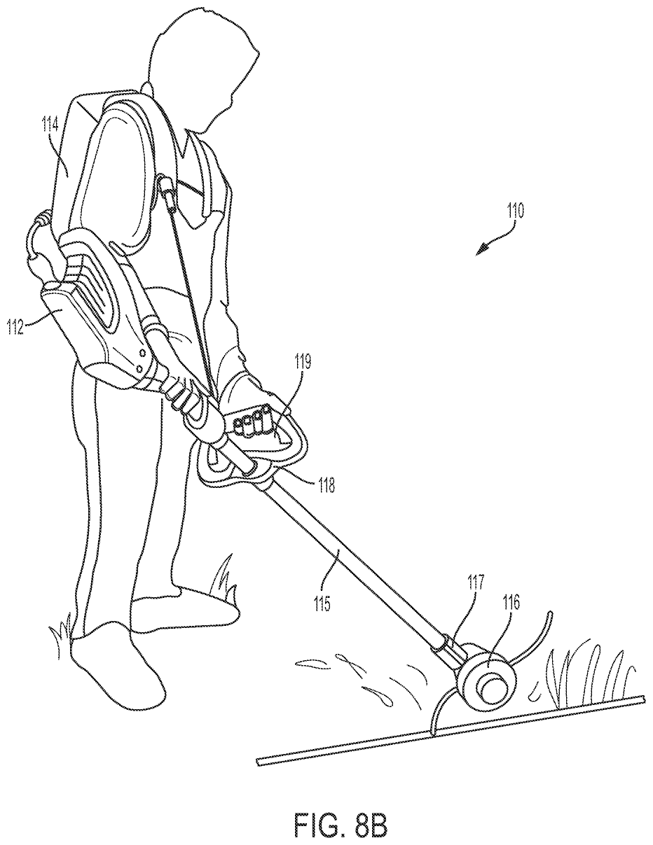

Next, referring to FIGS. 8A-8B, a hand-held string trimmer 110 in accordance with another aspect of the disclosure is shown. String trimmer 110 may include an electric motor 112, a front grip 118 that is at least partially rotatable about a shaft 115, and a rotary cutting head 116 disposed on an end of shaft 115. As with the various embodiments described above, string trimmer 110 may be powered by a one or more remote battery packs, which may be stored in a backpack 114. Alternatively, string trimmer 100 may include one or more on-board battery packs.

String trimmer 110 is configurable in both an “edge mode” and a “trim mode”, with the transitions between “edge mode” and “trim mode” being achieved via rotatable front grip 118, which is at least partially rotatable about the axis of shaft 115 so as to correspondingly rotate cutting head 116 about a coupler 117. In some embodiments, front grip 118, shaft 115, and coupler 117 may each be interconnected such that all rotate together when the user rotates front grip 118. Alternatively, in other embodiments, front grip 118 and coupler 117 may be interconnected via another connection means (not shown) such that angular rotation of front grip 118 and cutting head 116 may take place without corresponding rotation of shaft 115.

As illustrated in FIG. 8B, when a user rotates front grip 118 about the axis of shaft 115, cutting head 116 is correspondingly rotated such that string trimmer 100 is configured in the “edge mode”, with the rotary cutting head 116 positioned at a relatively steep angle ideal for edging. Conversely, in the configuration shown in FIG. 8A, when front grip 118 is in a substantially neutral (i.e., non-rotated) position relative to shaft 115, rotary cutting head 116 is positioned at a lesser angle ideal for vegetation trimming. An actuator 119 may be provided on front grip 118 so as to lock out the rotary cutting head 116 during changes in cutting head angle. In some embodiments, the rotary cutting head 116 may be limited to certain predetermined angular orientations (e.g., the two orientations shown in FIGS. 8A-8B). Alternatively, in other embodiments, rotary cutting head 116 may be adjustable in more than two orientations, and may be infinitely adjustable between two opposite extreme angular settings.

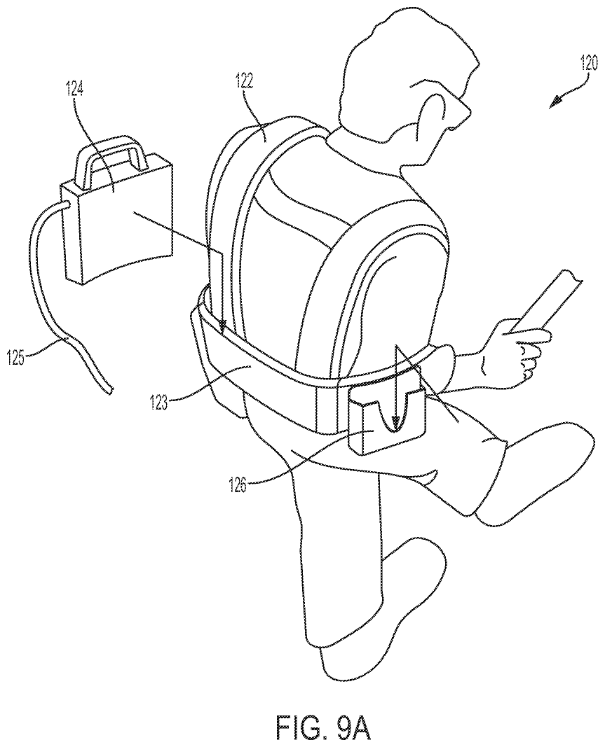

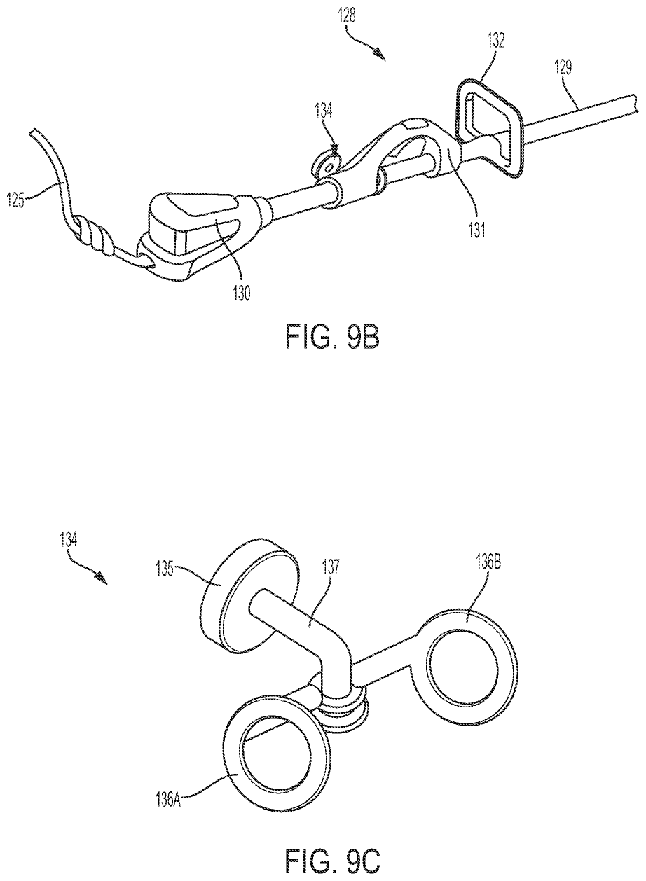

Referring now to FIGS. 9A-9C, a battery and tool support system 120 for a hand-held power tool (e.g., a hand-held string trimmer 128) in accordance with another aspect of the disclosure is shown. As shown in FIGS. 9A-9B, string trimmer 128 includes an electric motor 130 coupled to at least one battery pack 124 via a power cord 125, a shaft 129. While not shown, it is to be understood that string trimmer includes a rotary cutting head disposed at the end of shaft 129. A primary control handle 131 is provided, along with a secondary grip 132 to allow for increased control of string trimmer 128.

The at least one battery pack 124 may be supported on a carrier portion 123. As shown in FIG. 9A, in some embodiments, carrier portion may be configured as a hip belt, with an optional shoulder harness 122 provided for added support. On one side of the carrier portion 123 is a gimbal receptacle 126, which is ideally located proximate to the user's hip nearest their dominant hand. Gimbal receptacle 126 is configured to accept a gimbal 134 coupled to the string trimmer 128 so as to provide additional support from string trimmer 128, even when the string trimmer 128 is in use. Specifically, as shown in FIGS. 9A-9C, gimbal 134 may be configured substantially ball-and-socket-type join configuration, with a head portion 135 extending from a stem 137, as well as a pair of through-holes 136A, 136B configured to receive the shaft 129 of string trimmer 128. The head portion 135 is sized and configured to be receivable in the gimbal receptacle 126, which allows for multiple degrees of freedom of movement of string trimmer 128, while still transferring a substantial portion of the weight of string trimmer 128 to the carrier portion 123. Furthermore, gimbal 134 may be configured so to be movable along shaft 129 (or vice versa), thereby enabling the user to balance the weight of the string trimmer 128 by moving the gimbal 134 (or sliding shaft 129) axially with respect to the through-holes 136A, 136B.

Furthermore, because gimbal 134 provides a non-permanent connection between carrier portion 123 and string trimmer 128, the user may easily disconnect (and reconnect) string trimmer 128 from gimbal receptacle 126 when a particular application of string trimmer 128 is not conducive to the string trimmer 128 remaining coupled to gimbal receptacle 126. Additionally, while gimbal 134 is shown an described as a mechanical joint interface with gimbal receptacle 126, it is to be understood that any form of appropriate coupling may be possible, such as, e.g., a magnetic coupling, a hook-and-loop-based connection, a suction based connection, etc.

As illustrated in FIG. 9A, a removable battery pack 124 may be coupled to carrier portion 123 at or near the user's hip opposite the mounting location of gimbal receptacle 126. Accordingly, the weight of battery pack 124 may be utilized to counterbalance the weight of the string trimmer 128 when string trimmer 128 is mounted in gimbal receptacle 126. However, it is to be understood that the battery pack 124 may be located elsewhere on carrier portion 123 and/or shoulder harness 122, dependent upon user preferences and/or applications.

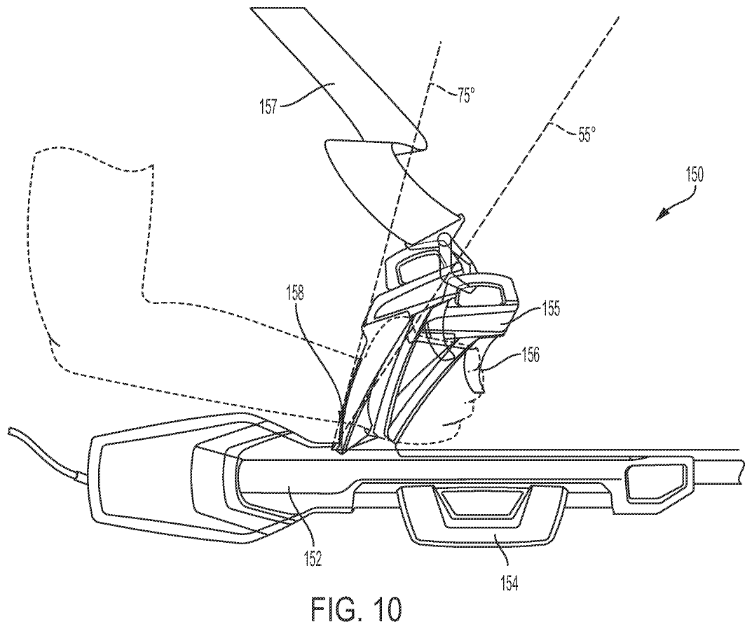

Next, referring to FIG. 10, a hand-held power tool 150 in accordance with another aspect of the disclosure is shown. Hand-held power tool 150 may be configured as, e.g., a string trimmer for use with a backpack system containing one or more battery packs, as described above. Hand-held power tool 150 may include a motor housing 152 on a proximal end thereof, wherein motor housing 152 is configured to hold at least one electric motor configured to drive an implement (e.g., a rotary head (not shown) of hand-held power tool 150. Additionally, hand-held power tool 150 may include a sliding counterweight 154, which may enable the center-of-gravity of hand-held power tool 150 to change dependent upon the angle of operation.

As opposed to a fixed handle portion, hand-held power tool 150 includes a ratcheting handle 155. Ratcheting handle 155 may include a trigger 156 for control of the implement(s) of power tool 150. Additionally, a strap 157 may be coupled to the ratcheting handle 155 at a first end and coupled to a backpack (not shown) at a second end so as to support at least some of the weight of power tool 150. Ratcheting handle may be configured to be angularly adjustable about a pivot point 158 based on user preference and/or a particular task. For example, as shown in FIG. 10, ratcheting handle 155 may be pivotable from a first angular orientation relative to the shaft of hand-held power tool 150 (e.g., 55°) to a second angular orientation (e.g., 75°).

While FIG. 10 illustrates ratcheting handle 155 as allowing for fore-and-aft angular adjustability, it is to be understood that ratcheting handle 155 may also (or alternatively) be angularly adjustable radially with respect to the shaft of hand-held power tool 150. In this way, the user may adjust ratcheting handle 155 to a position 90° displaced from a standard operation position. In a string trimmer application, such displacement may enable the user to operate the power tool 150 as a conventional string trimmer in a first orientation, and operate the power tool 150 as an edger in a second orientation.

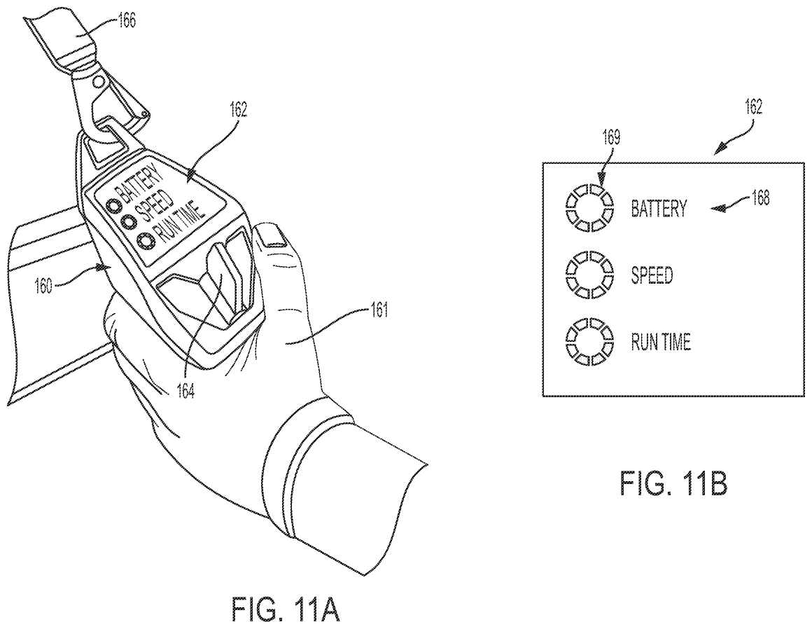

Referring now to FIGS. 11A-11B, a handle portion 160 for use with a hand-held power tool such as, e.g., a string trimmer, a blower, etc., in accordance with another aspect of the disclosure is shown. Handle portion 160 includes a display 162, wherein display 162 is configured to provide the user with information regarding the hand-held power tool. Display 162 may be, for example, a digital display, an LCD screen, a series of LED lights, or any other appropriate display means. In FIG. 11B, display 162 is shown as providing a variety of indicators to a user regarding the status of the power tool. For example, display 162 provides the user with a visual indication 168 of remaining battery life, implement speed, and remaining run time. In one embodiment, the remaining battery life, implement speed, and/or remaining run time is provided in the form of a respective circular LED incremental indicator 169. However, it is to be understood that any appropriate indicator may be utilized. As the hand-held power tool may be used with a backpack-housed battery pack, providing the user with an easily-visible indication of battery life and/or run time on the handle portion 160 allows the user to better plan for task completion and/or eventual battery pack replacement (or recharge) without having to remove the backpack system. While display 162 is shown as being located on handle portion 160, it is to be understood that display 162 may be located elsewhere on the hand-held power tool, at any location visible to the user.

Handle portion 160 may further include a thumb-activated switch or lever 164, which may be utilized for various operations of the hand-held power tool, such as, e.g., rotary head rotation, blower direction, herbicide spray application, etc. Additionally and/or alternatively, switch or lever 164 may be utilized to change between screens and/or indicators on display 162. Additionally, handle portion 160 may be couplable to a strap 166, which may also be coupled to the backpack system so as to support at least some of the weight of the hand-held power tool.

While FIGS. 1A-11B primarily illustrate various types of string trimmers (and/or backpack systems electrically couplable to string trimmers), it is to be understood that the features described herein may also be applicable to any other type of power tool, including other types of outdoor power equipment, such as, e.g., hand-held blowers, hand-held hedge trimmers, telescoping branch pruners, edgers, walk-behind lawnmowers, etc., as well as other types of electrically-driven power tools, such as, e.g., drills, saws, vacuums, etc.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

1. A backpack system for use with a power tool, the backpack system comprising:
a harness system, wherein the harness system is configured to extend at least over a user's shoulders;
a carrier portion, wherein the carrier portion is configured to be coupled to the harness system;
at least one battery pack housed within the carrier portion; and
at least one electrical connector coupled to the at least one battery pack and configured to provide power to the power tool,
wherein the carrier portion further comprises at least one opening formed therein to allow the passage of air at least partially through the carrier portion.

2. The backpack system of claim 1, wherein the at least one opening extends from a top section of the carrier portion to a bottom section of the carrier portion.

3. The backpack system of claim 1, further comprising at least one fan positioned in-line with the at least one opening formed within the carrier portion.

4. A backpack system for use with a power tool, the backpack system comprising:
a harness system, wherein the harness system is configured to extend at least over a user's shoulders;
a carrier portion, wherein the carrier portion is configured to be coupled to the harness system;
at least one battery pack housed within the carrier portion; and
at least one electrical connector coupled to the at least one battery pack and configured to provide power to the power tool,
wherein the carrier portion is removably couplable to the harness system.

5. The backpack system of claim 4, wherein the carrier portion is couplable to the harness system via one or more connectors.

6. The backpack system of claim 5, wherein the one or more connectors comprise at least one of one or more quarter-turn fasteners and one or more magnetic fasteners.

7. The backpack system of claim 4, wherein the harness system comprises a pair of shoulder straps.

8. The backpack system of claim 4, wherein the harness system comprises a vest.

9. The backpack system of claim 4, wherein the carrier portion further comprises a gimbal configured to support at least a portion of the weight of the hand-held power tool.

10. The backpack system of claim 4, wherein the power tool is an electric motor-driven string trimmer.

11. The backpack system of claim 10, wherein the string trimmer is coupled to the at least one battery pack within the carrier portion by an electrical cord.

12. The backpack system of claim 10, wherein the string trimmer comprises a rotary head at a distal end thereof, and further wherein the rotary head is configured rotate bi-directionally.

13. The backpack system of claim 10, wherein the string trimmer further comprises a handle portion, and wherein the handle portion comprises a pistol-type hand grip.

14. The backpack system of claim 13, wherein the handle portion is a ratcheting hand grip, the ratcheting hand grip configured to be angularly adjustable.

15. The backpack system of claim 10, wherein the string trimmer further comprises a hand grip and a forearm support, wherein both the hand grip and the forearm support are configured so as to allow the forearm support to rest on either a bottom portion or a top portion of the user's forearm.

16. The backpack system of claim 4, wherein the power tool further comprises a display portion, wherein the display portion is configured to display at least information related to the at least one battery pack housed within the carrier portion.

17.-23. (canceled)
